(19) United States
(12) Patent Application Publication
(10) Pub. No.: US 2025/0044676 A1
(43) Pub. Date: Feb. 6, 2025

(54) HARD COAT FILM FOR PROJECTION SCREEN AND PROJECTION SCREEN

(71) Applicant: LINTEC CORPORATION, Tokyo (JP)

(72) Inventor: Akihira WATANABE, Tokyo (JP)

(73) Assignee: LINTEC CORPORATION, Tokyo (JP)

(21) Appl. No.: 18/708,478

(22) PCT Filed: Nov. 8, 2022
(86) PCT No.: PCT/JP2022/041467

§ 371 Date: Oct. 29, 2024

(30) Foreign Application Priority Data
Nov. 9, 2021 (JP) 2021-182708

(51) Int. Cl. G03B 21/62; G02B 1/14; G02B 5/02

(52) U.S. Cl. CPC G03B 21/62; G02B 1/14; G02B 5/0278

(57) ABSTRACT

Provided is a hard coat film (1) for a projection screen, comprising: a base material film (11); and a hard coat layer (12) formed on one surface side of the base material film, wherein the total luminous haze value is 1% or more and 60% or less, and the ratio of a maximum haze value to a minimum haze value in a wavelength region of 400 nm to 700 nm is less than 7. According to the hard coat film (1) for a projection screen, it is possible to achieve both the visibility when a projector is turned on and the background visibility when the projector is turned off, and reduce color tone change.

### TECHNICAL FIELD

The present invention relates to a hard coat film for a projection screen and a projection screen that is used by being attached to an optically transparent adherend.

### BACKGROUND ART

In recent years, projectors have been used to display images (including the concept of video) in various places. Among these, as an example, a transmissive projection screen that is used by being attached to glass such as a show window is becoming known. The transmissive projection screen displays images projected from a projector to a viewer who is on the opposite side of the projector across the glass to which the transmissive projection screen is attached.

As an example of such a transmissive projection screen, one described in Patent Document 1 has been proposed. Specifically, a transparent screen having a coating film formed by curing a coating agent has been proposed. The coating agent contains predetermined amounts of an active energy ray-curable resin with a weight-average molecular weight of 2000 or less, a dispersant, and zirconia particles (primary particle diameter of 1 nm or more and 50 nm or less) or silica particles (primary particle diameter of 200 nm or more and 600 nm or less) as inorganic particles.

### PRIOR ART DOCUMENTS

### Patent Documents

[Patent Document 1]JP2019-199516A

### SUMMARY OF THE INVENTION

### Problems to be Solved by the Invention

Transmissive projection screens are required to have good visibility of images displayed on the projection screens when the projector is turned on. In particular, it is desired that not only the image visibility from the front but also the image visibility in a diagonal direction should be excellent. Moreover, when the projector is turned off, it is desired that the background on the opposite side of the glass or the like to which the projection screen is attached can be clearly seen. Furthermore, it is desired that there should be little change in the luminance depending on the type of display color in the image, that is, little color tone change.

With the projection screen described in Patent Document 1, however, the required performance as described above cannot be sufficiently obtained.

The present invention has been made in view of such actual circumstances, and an object of the present invention is to provide a hard coat film for a projection screen and a projection screen that are able to achieve both the visibility when the projector is turned on and the background visibility when the projector is turned off and that have little color tone change.

### Means for Solving the Problems

To achieve the above object, first, the present invention provides a hard coat film for a projection screen, comprising: a base material film; and a hard coat layer formed on one surface side of the base material film, wherein a total luminous haze value is 1% or more and 60% or less, and a ratio of a maximum haze value to a minimum haze value in a wavelength region of 400 nm to 700 nm is less than 7 (Invention 1).

By satisfying the above physical properties, when the projector is turned on, the hard coat film according to the above invention (Invention 1) is excellent in the image visibility in front of the projection screen including the hard coat film and the image visibility in a diagonal direction. Moreover, when the projector is turned off, the background on the opposite side of the projection screen including the hard coat film can be clearly seen, and the background visibility is thus excellent. Furthermore, there is little change in the luminance depending on the type of display color in the image, and the color tone change is little.

In the above invention (Invention 1), an average value of haze values in the wavelength region of 400 nm to 700 nm may be preferably 2.0% or more and 60% or less (Invention 2).

In the above invention or inventions (Inventions 1 and 2), an average value of luminous transmittances in the wavelength region of 400 nm to 700 nm may be preferably 60% or more and 98% or less (Invention 3).

In the above invention or inventions (Inventions 1 to 3), a total luminous transmittance may be preferably 60% or more (Invention 4).

In the above invention or inventions (Inventions 1 to 4), the hard coat layer may preferably contain light-diffusing fine particles (Invention 5).

In the above invention (Invention 5), the light-diffusing fine particles may preferably have a refractive index of 1.8 or more (Invention 6).

In the above invention or inventions (Inventions 5 and 6), a difference between a refractive index of a resin component constituting the hard coat layer and the refractive index of the light-diffusing fine particles may be preferably 0.5 or more in absolute value (Invention 7).

In the above invention or inventions (Inventions 1 to 7), a content of the light-diffusing fine particles in the hard coat layer may be preferably 0.01 mass parts or more and 10 mass parts or less with respect to 100 mass parts of a resin main component constituting the hard coat layer (Invention 8).

Second, the present invention provides a projection screen comprising: the hard coat film for a projection screen (any of Inventions 1 to 8); a pressure sensitive adhesive layer laminated on a surface side of the hard coat film for a projection screen opposite to the hard coat layer; and an optically transparent member laminated on a surface side of the pressure sensitive adhesive layer opposite to the hard coat film for a projection screen (Invention 9).

### Advantageous Effect of the Invention

According to the hard coat film for a projection screen and the projection screen of the present invention, it is possible to achieve both the visibility when the projector is turned on and the background visibility when the projector is turned off, and the color tone change is little.

### BRIEF DESCRIPTION OF DRAWINGS

FIG. 1 is a cross-sectional view illustrating a hard coat film for a projection screen according to an embodiment of the present invention.

FIG. 2 is a cross-sectional view illustrating a projection screen according to an embodiment of the present invention.

FIG. 3 is a plan view illustrating an example of use of the projection screen according to an embodiment of the present invention (an entire view including a projector when viewed from above).

### EMBODIMENTS FOR CARRYING OUT THE INVENTION

Hereinafter, one or more embodiments of the present invention will be described.

### <Hard Coat Film for Projection Screen>

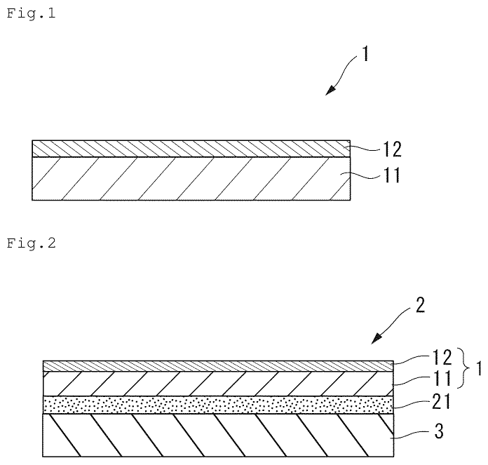

FIG. 1 is a cross-sectional view of a hard coat film for a projection screen according to an embodiment of the present invention. A hard coat film 1 for a projection screen (which may be simply referred to as “the hard coat film 1,” hereinafter) according to the present embodiment is configured to include a base material film 11 and a hard coat layer 12 formed on one surface side (the upper side in FIG. 1) of the base material film 11.

In the hard coat film 1 according to the present embodiment, the total luminous haze value may be preferably 1% or more and 60% or less, and the ratio of the maximum haze value to the minimum haze value in a wavelength region of 400 nm to 700 nm (visible light region) (maximum haze value/minimum haze value, which may be referred to as “the haze value ratio,” hereinafter) may be preferably less than 7. The method of measuring the haze value is as described in the testing example, which will be described later.

By satisfying the above physical properties, when the projector is turned on, the hard coat film 1 according to the present embodiment is excellent in the image visibility in front of the projection screen including the hard coat film 1 and the image visibility in a diagonal direction. Moreover, when the projector is turned off, the background on the opposite side of the projection screen including the hard coat film 1 can be clearly seen, and the background visibility is thus excellent. Furthermore, there is little change in the luminance depending on the type of display color in the image, and the color tone change is little. Examples of the type of display color include blue (B) for short wavelengths (400 nm to 500 nm), green (G) for medium wavelengths (500 nm to 600 nm), and red (R) for long wavelengths (600 nm to 700 nm).

From the viewpoint of the above effects, especially the visibility when the projector is turned on, the total luminous haze value of the hard coat film 1 may be preferably 1% or more, more preferably 2% or more, particularly preferably 3% or more, and further preferably 5% or more. Additionally or alternatively, from the viewpoint of the above effects, especially the background visibility when the projector is turned off, the total luminous haze value of the hard coat film 1 may be preferably 60% or less, more preferably 35% or less, particularly preferably 20% or less, and further preferably 15% or less.

From the viewpoint of suppressing the color tone change, the above haze value ratio may be preferably less than 7, more preferably 5 or less, particularly preferably 3 or less, and further preferably 2 or less. The lower limit of the above haze value ratio is most preferably 1, but may be usually preferably 1.001 or more, more preferably 1.01 or more, particularly preferably 1.05 or more, and further preferably 1.1 or more.

The minimum haze value of the hard coat film 1 according to the present embodiment in the wavelength region of 400 nm to 700 nm may be preferably 1.0% or more, more preferably 1.5% or more, particularly preferably 2.0% or more, and further preferably 3.0% or more. This allows the above haze value ratio to be readily satisfied. The upper limit of the above minimum haze value is not particularly limited, but may be preferably 30% or less, more preferably 20% or less, particularly preferably 15% or less, and further preferably 10% or less.

The maximum haze value of the hard coat film 1 according to the present embodiment in the wavelength region of 400 nm to 700 nm may be preferably 60% or less, more preferably 40% or less, particularly preferably 20% or less, and further preferably 15% or less. This allows the above haze value ratio to be readily satisfied. The lower limit of the above maximum haze value is not particularly limited, but may be preferably 3.0% or more, more preferably 4.0% or more, particularly preferably 5.0% or more, and further preferably 6.0% or more.

The average value of haze values of the hard coat film 1 according to the present embodiment in the wavelength region of 400 nm to 700 nm (visible light region) may be preferably 2.0% or more, more preferably 3.0% or more, particularly preferably 4.0% or more, and further preferably 5.5% or more. Additionally or alternatively, the average value of the haze values may be preferably 60% or less, more preferably 40% or less, particularly preferably 20% or less, and further preferably 15% or less. When the above average value of the haze values is within the above range, the visibility when the projector is turned on and the background visibility when the projector is turned off can be more excellent.

The average value of luminous transmittances of the hard coat film 1 according to the present embodiment in the wavelength region of 400 nm to 700 nm (visible light region) may be preferably 60% or more, more preferably 70% or more, particularly preferably 75% or more, and further preferably 85% or more. This allows the background visibility when the projector is turned off to be more excellent. Additionally or alternatively, the above average value of luminous transmittances may be preferably 98% or less, more preferably 97% or less, particularly preferably 96% or less, and further preferably 95% or less. This allows the visibility when the projector is turned on to be more excellent. The method of measuring the luminous transmittance is as described in the testing example, which will be described later.

The total luminous transmittance of the hard coat film 1 according to the present embodiment may be preferably 60% or more, more preferably 70% or more, particularly preferably 75% or more, and further preferably 85% or more. This allows the background visibility when the projector is turned off to be more excellent. Additionally or alternatively, the above total luminous transmittance may be preferably 98% or less, more preferably 97% or less, particularly preferably 96% or less, and further preferably 95% or less. This allows the visibility when the projector is turned on to be more excellent.

When the hard coat film 1 according to the present embodiment is imparted with near-infrared absorptivity, the luminous transmittance at a wavelength of 1100 nm may be preferably 60% or less, more preferably 50% or less, particularly preferably 40% or less, and further preferably 30% or less. When the luminous transmittance at a wavelength of 1100 nm is as described above, the hard coat film 1 can suppress an increase in the temperature due to sunlight or the like. The lower limit of the luminous transmittance at a wavelength of 1100 nm is not particularly limited, but may be preferably 0.001% or more, more preferably 0.01% or more, particularly preferably 0.1% or more, and further preferably 1% or more.

### 1. Each Element

### 1-1. Base Material Film

The base material film 11 in the present embodiment is not particularly limited, provided that it can hold the hard coat layer 12 and does not hinder the image visibility. Examples of such a base material film 11 include films of polyesters such as polyethylene terephthalate, polybutylene terephthalate, and polyethylene naphthalate, polyolefin films such as polyethylene films and polypropylene films, cellophane, diacetyl cellulose films, triacetyl cellulose films, acetyl cellulose butyrate films, polyvinyl chloride films, polyvinylidene chloride films, polyvinyl alcohol films, ethylene-vinyl acetate copolymer films, polystyrene films, polycarbonate films, polymethylpentene films, polysulfone films, polyetheretherketone films, polyethersulfone films, polyether imide films, fluororesin films, polyamide films, acrylic resin films, polyurethane resin films, norbornene-based polymer films, cyclic olefin-based polymer films, cyclic conjugated diene-based polymer films, vinyl alicyclic hydrocarbon polymer films, other similar plastic films, and laminated films thereof. Among these, polyethylene terephthalate films, polycarbonate films, or the like may be preferred from the viewpoint of transparency, mechanical strength, etc.

For the purpose of improving the interfacial adhesion of the base material film 11 with a layer (such as the hard coat layer 12 or a pressure sensitive adhesive layer) provided on the surface of the base material film 11, one surface or both surfaces of the base material film 11 may be subjected to surface treatment, such as using primer treatment, oxidation method, or roughening method, as necessary. Examples of the oxidation method include corona discharge treatment, chromic acid treatment, flame treatment, hot-air treatment, and ozone/ultraviolet treatment. Examples of the roughening method include a sandblast method and a solvent treatment method. These surface treatment methods may be appropriately selected depending on the type of the plastic film, and the corona discharge treatment method may be preferably used in view of the effect, the operability, etc. in general.

The thickness of the base material film 11 may be preferably 10 to 300 μm, more preferably 20 to 2500 μm, particularly preferably 25 to 200 μm, and further preferably 30 to 150 μm from the viewpoint of handling properties, transparency, mechanical strength, etc.

### 1-2. Hard Coat Layer

Preferably, the hard coat layer 12 satisfies the previously described optical properties and has a predetermined hardness. Specifically, the hard coat layer 12 may be preferably composed of a material obtained by curing a composition that contains an active energy ray-curable component. In particular, the hard coat layer 12 may be preferably composed of a material obtained by curing a composition that contains an active energy ray-curable component and light-diffusing fine particles (this composition may be referred to as a “composition for hard coat layer,” hereinafter).

### (1) Each Component

### (1-1) Active Energy Ray-curable Component

The active energy ray-curable component may be preferably a component that can be cured by irradiation with active energy rays to exhibit a predetermined hardness, and may be particularly preferably a component that can achieve the refractive index difference, which will be described later, in relation to the light-diffusing fine particles.

Specific examples of the active energy ray-curable component include polyfunctional (meth)acrylate-based monomer, (meth)acrylate-based prepolymer, and active energy ray-curable polymer, among which the polyfunctional (meth)acrylate-based monomer and/or the (meth)acrylate-based prepolymer may be preferred. The polyfunctional (meth)acrylate-based monomer and the (meth)acrylate-based prepolymer may each be used alone or both may also be used in combination. As used in the present specification, the (meth)acrylate refers to both an acrylate and a methacrylate. The same applies to other similar terms.

Examples of the polyfunctional (meth)acrylate-based monomer include 1,4-butanediol di(meth)acrylate, 1,6-hexanediol di(meth)acrylate, neopentyl glycol di(meth)acrylate, polyethylene glycol di (meth) acrylate, hydroxypivalic acid neopentyl glycol di(meth)acrylate, dicyclopentanyl di(meth)acrylate, caprolactone-modified dicyclopentenyl di(meth)acrylate, ethylene oxide-modified phosphoric acid di(meth)acrylate, allylated cyclohexyl di(meth)acrylate, isocyanurate di (meth)acrylate, trimethylol propane tri(meth)acrylate, dipentaerythritol tri(meth)acrylate, propionic acid-modified dipentaerythritol tri(meth)acrylate, pentaerythritol tri(meth)acrylate, propylene oxide-modified trimethylolpropane tri(meth)acrylate, tris (acryloxyethyl)isocyanurate, propionic acid-modified dipentaerythritol penta(meth)acrylate, dipentaerythritol hexa(meth)acrylate, ethylene oxide-modified dipentaerythritol hexa(meth)acrylate, caprolactone-modified dipentaerythritol hexa(meth)acrylate, and other appropriate polyfunctional (meth)acrylates. These may each be used alone or two or more types may also be used in combination. Among the above, those having 3 to 6 functional groups may be preferred, and those having 4 to 6 may be particularly preferred, from the viewpoint of scratch resistance.

On the other hand, examples of the (meth)acrylate-based prepolymer include polyester acrylate-based, epoxy acrylate-based, urethane acrylate-based, and polyol acrylate-based prepolymers. Among the above, urethane acrylate-based prepolymers may be preferred, and polyfunctional urethane acrylate-based prepolymers may be particularly preferred, from the viewpoint of curl suppression.

The polyester acrylate-based prepolymer can be obtained, for example, through preparing a polyester oligomer having hydroxyl groups at both ends, which is obtained by condensation of a polycarboxylic acid and a polyalcohol, and esterifying the hydroxyl groups of the polyester oligomer with (meth)acrylic acid, or through preparing an oligomer obtained by adding an alkylene oxide to a polycarboxylic acid and esterifying the hydroxyl group at an end of the oligomer with (meth)acrylic acid.

The epoxy acrylate-based prepolymer can be obtained, for example, through reacting (meth)acrylic acid with the oxirane ring of a relatively low-molecular-weight bisphenol-type epoxy resin or novolak-type epoxy resin to esterify it.

The urethane acrylate-based prepolymer can be obtained, for example, through preparing a polyurethane oligomer obtained by a reaction between a polyether polyol or a polyester polyol and a polyisocyanate and esterifying the polyurethane oligomer with (meth)acrylic acid.

The polyol acrylate-based prepolymer can be obtained, for example, through esterifying a hydroxyl group of a polyether polyol with (meth)acrylic acid.

The above prepolymers may each be used alone or two or more types may also be used in combination.

When the polyfunctional (meth)acrylate-based monomer and the (meth)acrylate-based prepolymer are used in combination, the mass ratio thereof may be preferably 10:90 to 90:10, more preferably 20:80 to 80:20, particularly preferably 25:75 to 75:25, and further preferably 30:70 to 70:30.

### (1-2) Light-Diffusing Fine Particles

The composition for hard coat layer constituting the hard coat layer 12 of the present embodiment may preferably contain light-diffusing fine particles. By containing the light-diffusing fine particles, the previously described optical properties can be readily satisfied.

The light-diffusing fine particles may be of any type, provided that they can satisfy the previously described optical properties, but inorganic fine particles may be particularly preferred. Examples of inorganic fine particles include metal oxides such as silica, aluminum oxide, zirconium oxide, titanium oxide, zinc oxide, germanium oxide, indium oxide, tin oxide, indium tin oxide (ITO), antimony oxide, and cerium oxide; and fine particles composed of metal fluorides and the like such as magnesium fluoride and sodium fluoride. Among these, metal oxides may be preferred, transition metal oxides may be more preferred, and titanium oxide, which can readily satisfy the previously described optical properties, may be particularly preferred. According to such fine particles, Mie scattered light becomes dominant, and the scattering region becomes wider, thus allowing the previously described physical properties to be readily obtained. The surfaces of inorganic fine particles may be chemically modified with an organic compound or the like.

The shape of the inorganic fine particles may be any of true spherical shape, indefinite shape, etc., but from the viewpoint of efficiently exhibiting the light-diffusing properties with a small amount, the infinite shape may be preferred.

The light-diffusing fine particles in the present embodiment may be preferably so-called nanoparticles. Specifically, the average particle diameter of the light-diffusing fine particles may be preferably 1000 nm or less, more preferably 700 nm or less, particularly preferably 400 nm or less, and further preferably 200 nm or less. Additionally or alternatively, the average particle diameter of the light-diffusing fine particles may be preferably 2 nm or more, more preferably 10 nm or more, particularly preferably 50 nm or more, and further preferably 100 nm or more. When the average particle diameter of the light-diffusing fine particles is within the above range, the previously described optical properties may be more readily satisfied. The average particle diameter of the light-diffusing fine particles is measured by a laser diffraction/scattering method.

The refractive index of the light-diffusing fine particles in the present embodiment may be preferably 1.8 or more, more preferably 1.9 or more, particularly preferably 2.1 or more, and further preferably 2.5 or more. Additionally or alternatively, the refractive index of the light-diffusing fine particles may be preferably 4.0 or less, more preferably 3.0 or less, particularly preferably 2.9 or less, and further preferably 2.8 or less. When the refractive index of the light-diffusing fine particles is within the above range, the previously described optical properties may be more readily satisfied. The refractive index of the light-diffusing fine particles can be measured, for example, by the following method. That is, a sample is prepared through placing fine particles on a slide glass, dropping a refractive index standard solution onto the fine particles, and covering the fine particles with a cover glass. The sample is observed with a microscope, and the refractive index of the refractive index standard solution at which the outline of the fine particles becomes most difficult to see may be determined as the refractive index of the fine particles.

The content of light-diffusing fine particles in the composition for hard coat layer may be preferably 0.01 mass parts or more, more preferably 0.1 mass parts or more, particularly preferably 0.2 mass parts or more, and further preferably 0.4 mass parts or more with respect to 100 mass parts of the active energy ray-curable component (resin component constituting the hard coat layer). Additionally or alternatively, the content may be preferably 10 mass parts or less, more preferably 5.0 mass parts or less, particularly preferably 2.0 mass parts or less, and further preferably 0.8 mass parts or less. This allows the previously described optical properties to be more readily satisfied.

The content of the inorganic fine particles can be determined from the compounding ratio, but if the compounding ratio is unknown, the content of the inorganic fine particles can be determined as follows. That is, a part of the hard coat layer 12 of the hard coat film 1 is separated from the base material film 13 as fragments or the like, and the organic components of the separated fragments of the hard coat layer 12 are burned in accordance with JIS 7250-1. Then, the mass % of inorganic fine particles can be determined from the obtained ash.

### (1-3) Photopolymerization Initiator

When ultraviolet rays are used as the active energy rays for curing the active energy ray-curable component, the above composition for hard coat layer may preferably contain a photopolymerization initiator. By containing the photopolymerization initiator in this way, the active energy ray-curable component can be efficiently polymerized, and the polymerization curing time and the irradiance level of ultraviolet rays can be reduced.

Examples of such photopolymerization initiators include benzoin, benzoin methyl ether, benzoin ethyl ether, benzoin isopropyl ether, benzoin-n-butyl ether, benzoin isobutyl ether, acetophenone, dimethylaminoacetophenone, 2,2-dimethoxy-2-phenylacetophenone, 2,2-diethoxy-2-phenylacetophenone, 2-hydroxy-2-methyl-1-phenylpropan-1-one, 1-hydroxycyclohexyl phenyl ketone, 2-methyl-1-[4-(methylthio)phenyl]-2-morpholino-propan-1-one, 4-(2-hydroxyethoxy)phenyl-2-(hydroxy-2-propyl)ketone, benzophenone, p-phenylbenzophenone, 4,4′-diethylaminobenzophenone, dichlorobenzophenone, 2-methylanthraquinone, 2-ethylanthraquinone, 2-tert-butylanthraquinone, 2-aminoanthraquinone, 2-methylthioxanthone, 2-ethylthioxanthone, 2-chlorothioxanthone, 2,4-dimethylthioxanthone, 2,4-diethylthioxanthone, benzyl dimethyl ketal, acetophenone dimethyl ketal, p-dimethylaminobenzoic ester, oligo[2-hydroxy-2-methyl-1[4-(1-methylvinyl)phenyl]propanone], and 2,4,6-trimethylbenzoyl-diphenyl-phosphine oxide. These may each be used alone or two or more types may also be used in combination.

The content of the photopolymerization initiator in the composition for hard coat layer may be preferably 0.01 mass parts or more, particularly preferably 0.1 mass parts or more, and further preferably 1 mass part or more as the lower limit with respect to 100 mass parts of the active energy ray-curable component. Additionally or alternatively, the content may be preferably 20 mass parts or less, particularly preferably 10 mass parts or less, and further preferably 5 mass parts or less as the upper limit.

### (1-4) Other Components

The composition for hard coat layer constituting the hard coat layer 12 of the present embodiment may contain various additives in addition to the previously described components. Examples of such additives include leveling agents, anti-glare property imparting agents, (near) infrared absorbers, ultraviolet absorbers, antioxidants, light stabilizers, antistatics, silane coupling agents, anti-aging agents, thermal polymerization inhibitors, colorants, surfactants, storage stabilizers, plasticizers, glidants, antifoamers, and wettability improvers.

Examples of leveling agents include silicone-based leveling agents, fluorine-based leveling agents, acrylic-based leveling agents, and vinyl-based leveling agents, among which silicone-based leveling agents may be preferred from the viewpoint of leveling properties and compatibility with other components. One type of leveling agent may be used alone, or two or more types may also be used in combination.

As the silicone-based leveling agent, polydimethylsiloxane or modified polydimethylsiloxane may be preferred, and as the modified polydimethylsiloxane, polyether-modified polydimethylsiloxane may be preferred.

The content of the leveling agent in the composition for hard coat layer may be preferably 0.01 mass parts or more, particularly preferably 0.05 mass parts or more, and further 0.1 mass parts or more as the lower limit with respect to 100 mass parts of the active energy ray-curable component. Additionally or alternatively, the amount may be preferably 5 mass parts or less, particularly preferably 1 mass part or less, and further preferably 0.5 mass parts or less as the lower limit. When the content of the leveling agent is within the above range, the formed hard coat layer 12 can have excellent smoothness.

As the anti-glare property imparting agent, fillers other than the previously described light-diffusing fine particles and having a relatively large particle diameter can be used. Examples of such fillers include inorganic-based fine particles such as silica, calcium carbonate, aluminum hydroxide, magnesium hydroxide, clay, talc, and titanium dioxide; organic-based fine particles such as acrylic resin, polystyrene resin, polyethylene resin, and epoxy resin; and fine particles composed of a silicon-containing compound having a structure intermediate between inorganic and organic structures (e.g., TOSPEARL series available from Momentive Performance Materials Japan, which are fine particles of silicone resin). These fillers may each be used alone or two or more types may also be used in combination.

Examples of fine particles composed of the above acrylic resin include a homopolymer of methyl methacrylate, a copolymer of methyl methacrylate and a monomer such as vinyl acetate, styrene, methyl acrylate, or ethyl (meth)acrylate.

The shape of the filler may be a definite shape such as a spherical shape, or an indefinite shape whose shape is not specified.

The average particle diameter of the filler may be preferably 0.3 μm or more, particularly preferably 0.5 μm or more, and further preferably 1.0 μm or more. Additionally or alternatively, the average particle diameter of the filler may be preferably 10 μm or less, preferably 8.0 μm or less, particularly preferably 5.0 μm or less, and further preferably 3.0 μm or less. When the average particle diameter of the filler is within the above range, anti-glare properties can be exhibited satisfactorily. The average particle diameter of the filler is measured by a centrifugal sedimentation light transmission method.

The content of the anti-glare property imparting agent in the composition for hard coat layer may be preferably 0.1 mass parts or more, particularly preferably 1.0 mass parts or more, and further preferably 3.0 mass parts or more as the lower limit with respect to 100 mass parts of the active energy ray-curable component. Additionally or alternatively, the content may be preferably 20 mass parts or less, particularly preferably 15 mass parts or less, and further preferably 10 mass parts or less as the upper limit. When the content of the anti-glare property imparting agent is within the above range, the anti-glare properties can be exhibited satisfactorily, and the background reflection of external light can be effectively suppressed.

Examples of the near-infrared absorbers include phthalocyanine-based compounds, immonium-based compounds, thiol complex-based compounds, and cesium tungsten oxide-based compounds, among which cesium tungsten oxide-based compounds may be preferred. These near-infrared absorbers can each be used alone, or two or more types may also be used in combination.

The content of the near-infrared absorber in the composition for hard coat layer may be preferably 3.0 mass parts or more, particularly preferably 5.0 mass parts or more, and further preferably 10 mass parts or more as the lower limit with respect to 100 mass parts of the active energy ray-curable component. Additionally or alternatively, the content may be preferably 50 mass parts or less, particularly preferably 40 mass parts or less, and further preferably 30 mass parts or less as the upper limit. When the content of the near-infrared absorber is within the above range, the luminous transmittance at a wavelength of 1100 nm can be readily set within the previously described range.

### (2) Physical Properties

### (2-1) Thickness

The thickness of the hard coat layer 12 may be preferably 1.0 μm or more, more preferably 1.5 μm or more, particularly preferably 2.0 μm or more, and further preferably 3.0 μm or more. Additionally or alternatively, the thickness of the hard coat layer 12 may be preferably 20 μm or less, more preferably 15 μm or less, particularly preferably 10 μm or less, and further preferably 8.0 μm or less. When the thickness of the hard coat layer 12 is within the above range, the previously described optical properties can be readily satisfied, a predetermined surface hardness can be obtained, and the scratch resistance can be excellent.

### (2-2) Refractive Index

The difference between the refractive index of the resin component (cured product of the active energy ray-curable component and photopolymerization initiator) constituting the hard coat layer 12 and the refractive index of the light-diffusing fine particles may be preferably 0.5 or more, more preferably at 0.7 or more, particularly preferably 0.9 or more, and further preferably 1.0 or more in absolute value. This allows the previously described optical properties to be readily satisfied. From the viewpoint that the optical properties can be easily adjusted, the upper limit of the above refractive index difference may be preferably 3.0 or less, more preferably 2.0 or less, particularly preferably 1.7 or less, and further preferably 1.4 or less in absolute value.

The refractive index of the resin component (cured product of the active energy ray-curable component and photopolymerization initiator) constituting the hard coat layer 12 may be preferably 3.0 or less, more preferably 2.0 or less, particularly preferably 1.8 or less, and further preferably 1.6 or less. This allows the above refractive index difference to be readily satisfied. From the viewpoint that the material selection is easy, the lower limit of the refractive index of the above resin component may be preferably 1.0 or more, more preferably 1.1 or more, particularly preferably 1.2 or more, and further preferably 1.4 or more. The method of measuring the refractive index of the resin component is as described in the testing example, which will be described later.

### 2. Method of Producing Hard Coat Film

The hard coat film 1 according to the present embodiment can be preferably produced by the following method. In this method, for example, a composition for hard coat layer containing an active energy ray-curable component is used.

First, a composition layer composed of the composition for hard coat layer may be formed on one surface of the base material film 11. At this time, one surface of the base material film 11 may be directly coated with the composition for hard coat layer to form the composition layer, or after coating a cover sheet with the composition for hard coat layer, the composition layer with the cover sheet may be attached to one main surface of the base material film 11.

Any desired resin film can be used as the cover sheet. It is also possible to use a release sheet in which one or both surfaces of the resin film are subjected to a release treatment using a release agent.

The composition layer may be formed through preparing a coating liquid that contains the composition for hard coat layer and may further contain a solvent if desired, coating the base material film 11 or the cover sheet with the coating liquid, and drying it. The coating with the coating liquid may be performed by an ordinary method, such as a bar coating method, a knife coating method, a Meyer bar method, a roll coating method, a blade coating method, a die coating method, or a gravure coating method. Drying can be performed, for example, by heating at 40° C. to 180° C. for about 30 seconds to 5 minutes.

Examples of solvents include aliphatic hydrocarbons such as hexane and heptane, aromatic hydrocarbons such as toluene and xylene, halogenated hydrocarbons such as methylene chloride and ethylene chloride, alcohols such as methanol, ethanol, propanol, butanol, and propylene glycol monomethyl ether, ketones such as acetone, methyl ethyl ketone, methyl isobutyl ketone, 2-pentanone, isophorone, and cyclohexanone, esters such as ethyl acetate and butyl acetate, and cellosolve-based solvents such as ethyl cellosolve. Only one type of solvent may be used, or a mixture of two or more types may also be used. The concentration/viscosity of the coating liquid is not particularly limited, provided that the coating liquid is within a range in which coating is possible, and the concentration/viscosity can be appropriately selected depending on the situation.

Then, the above composition layer may be irradiated with active energy rays to cure it into the hard coat layer 12.

Ultraviolet rays, electron rays, etc. can be used as the active energy rays. Irradiation with ultraviolet rays can be performed by using a high-pressure mercury lamp, a fusion H lamp, a xenon lamp, or the like, and the irradiance level of ultraviolet rays may be preferably about 50 to 1000 mW/cm² as the illuminance and about 50 to 1000 mJ/cm² as the light amount. On the other hand, irradiation with electron rays can be performed by using an electron ray accelerator or the like, and the irradiance level of electron rays may be preferably about 10 to 1000 krad.

When using ultraviolet rays as the active energy rays, it may be preferred to irradiate the composition layer with ultraviolet rays in a state in which it is shielded from oxygen. This allows the hard coat layer 12 with high surface hardness to be effectively formed without being inhibited from curing due to oxygen.

To shield the above composition layer from oxygen, if the composition layer has a cover sheet attached thereto, the cover sheet may be left attached as it is, and if the composition layer does not have a cover sheet attached, it may be preferred to newly laminate a cover sheet on the above composition layer, or to place a laminate of the base material film 11 and the composition layer under an atmosphere with a low oxygen concentration, preferably under a nitrogen atmosphere.

### <Projection Screen>

The projection screen according to an embodiment of the present invention includes the previously described hard coat film for a projection screen, a pressure sensitive adhesive layer laminated on a surface side of the hard coat film for a projection screen opposite to the hard coat layer, and an optically transparent member laminated on a surface side of the pressure sensitive adhesive layer opposite to the hard coat film for a projection screen.

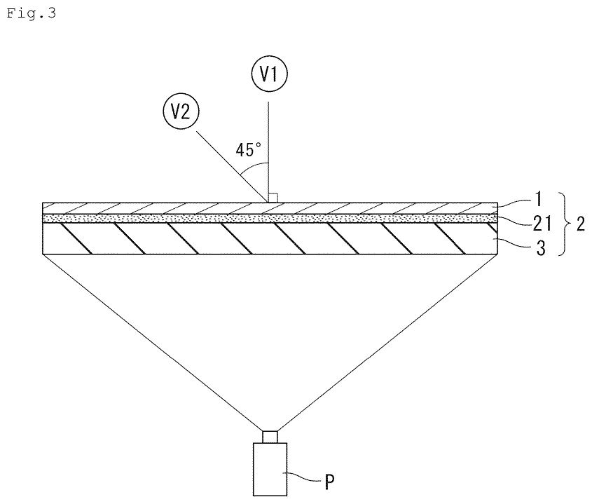

FIG. 2 illustrates a cross-sectional view of the projection screen according to an embodiment of the present invention. FIG. 3 illustrates an example of use of the projection screen according to an embodiment of the present invention (an entire view including a projector when viewed from above).

As illustrated in FIGS. 2 and 3, a projection screen 2 according to the present embodiment includes the hard coat film 1 for a projection screen, a pressure sensitive adhesive layer 21 laminated on the base material film 11 side of the hard coat film 1 for a projection screen, and an optically transparent member 3 laminated on a surface of the pressure sensitive adhesive layer 21 opposite to the hard coat film 1 for a projection screen.

### 1. Each Element

### 1-1. Hard Coat Film

The hard coat film 1 in the present embodiment is that in the previously described embodiment.

### 1-2. Pressure Sensitive Adhesive Layer

The pressure sensitive adhesive layer 21 in the present embodiment is not particularly limited, provided that it can attach the hard coat film 1 to the optically transparent member 3. If a laminate of the hard coat film 1 and the pressure sensitive adhesive layer 21 (hard coat film with pressure sensitive adhesive layer) is intended to be released from the optically transparent member 3 and furthermore to be reused, the pressure sensitive adhesive layer 21 may preferably have releasability (reworkability).

The pressure sensitive adhesive constituting the pressure sensitive adhesive layer 21 is not particularly limited, and known pressure sensitive adhesives can be used, such as acrylic-based pressure sensitive adhesives, rubber-based pressure sensitive adhesives, and silicone-based pressure sensitive adhesives and it may be preferred to use, among the above, the acrylic pressure-sensitive adhesives having excellent pressure sensitive adhesive properties and optical properties.

It is also preferred that the above pressure sensitive adhesive should contain an ultraviolet absorber. Examples of ultraviolet absorbers include benzophenone-based, benzotriazole-based, benzoate-based, benzoxazinone-based, triazine-based, phenyl salicylate-based, cyanoacrylate-based, and nickel complex salt-based compounds. These may each be used alone or two or more types may also be used in combination.

When the above pressure sensitive adhesive contains an ultraviolet absorber, the content of the ultraviolet absorber may be preferably 0.01 to 30 mass %, particularly preferably 0.1 to 15 mass %, and further preferably 1 to 10 mass %.

From the viewpoint of pressure sensitive adhesive properties, the thickness of the pressure sensitive adhesive layer 21 may be preferably 5 μm or more, more preferably 10 μm or more, particularly preferably 15 μm or more, and further preferably 25 μm or more. Additionally or alternatively, from the viewpoint of reworkability, the thickness of the pressure sensitive adhesive layer 21 may be preferably 200 μm or less, more preferably 150 μm or less, particularly preferably 100 μm or less, and further preferably 50 μm or less.

### 1-3. Optically Transparent Member

The optically transparent member 3 may be a transparent hard plate such as a glass plate or a plastic plate or a flexible transparent body such as a plastic film. Examples of the optically transparent member 3 include, but are not limited to, show window glass; architectural glass such as window glass, exterior wall glass, or partition glass; glass installed at event site; and window glass of various vehicles.

### 1-4. Release Sheet

A release sheet (not illustrated) may be laminated on the pressure sensitive adhesive layer 21 before being attached to the optically transparent member 3 on the opposite side to the hard coat film 1. This release sheet may be removed from the pressure sensitive adhesive layer 21 when the pressure sensitive adhesive layer 21 is attached to the optically transparent member 3.

The release sheet is not particularly limited, provided that it does not adversely affect the pressure sensitive adhesive layer 21. Examples of the release sheet 13 for use include polyethylene films, polypropylene films, polybutene films, polybutadiene films, polymethylpentene films, polyvinyl chloride films, vinyl chloride copolymer films, polyethylene terephthalate films, polyethylene naphthalate films, polybutylene terephthalate films, polyurethane films, ethylene vinyl acetate films, ionomer resin films, ethylene/(meth)acrylic acid copolymer films, ethylene/(meth)acrylic ester copolymer films, polystyrene films, polycarbonate films, polyimide films, and fluororesin films. Moreover, these crosslinked films may also be used. Furthermore, these laminated films may be used. Among the above, polyethylene terephthalate films may be preferred because of their excellent handling properties.

The surface of the above release sheet to be in contact with the pressure sensitive adhesive layer 21 may be subjected to a release treatment. Examples of release agents used for the release treatment include alkyd-based, silicone-based, fluorine-based, unsaturated polyester-based, polyolefin-based, and wax-based release agents.

The thickness of the release sheet is not particularly limited, but may be usually preferably 15 to 100 μm and particularly preferably 25 to 75 μm.

### 2. Production Method

To produce the projection screen 2 according to the present embodiment, for example, a surface of the hard coat film 1 opposite to the hard coat layer 12 may be coated with a coating liquid that contains a pressure sensitive adhesive and that may further contain a diluent if desired, and the coating liquid may then be dried to cure to form the pressure sensitive adhesive layer 21.

The above diluent is not particularly limited, and various diluents can be used. For example, hydrocarbon compounds such as toluene, hexane, and heptane as well as acetone, ethyl acetate, methyl ethyl ketone, methyl isobutyl ketone, and mixtures thereof may be used.

The coating with the coating liquid of the pressure sensitive adhesive composition may be performed by an ordinary method, such as a bar coating method, a knife coating method, a roll coating method, a blade coating method, a die coating method, or a gravure coating method. After the coating with the above coating liquid, it is preferred to heat and dry the coating film.

Once the pressure sensitive adhesive layer 21 is formed as described above, the pressure sensitive adhesive layer 21 and the optically transparent member 3 may be attached to each other to obtain the projection screen 2. If desired, a release sheet may be attached to the pressure sensitive adhesive layer 21 after its formation, and the release sheet may be removed before the pressure sensitive adhesive layer 21 is attached to the optically transparent member 3.

In the above production method, the pressure sensitive adhesive layer 21 is formed on the hard coat film 1, but the pressure sensitive adhesive layer 12 may be formed on a release sheet, and the hard coat film 1 may then be attached to the pressure sensitive adhesive layer 21.

### 3. Physical Properties

In the projection screen 2 according to the present embodiment, the luminance at frontal 0° (directly in front of a light source) (frontal 0° luminance) on the hard coat film 1 side as measured using transmitted light from a white light source of 1100 cd/m² may be preferably 10 cd/m² or more, more preferably 20 cd/m² or more, particularly preferably 30 cd/m² or more, and further preferably 50 cd/m² or more. This allows the frontal image visibility to be excellent when the projector is turned on. Additionally or alternatively, the above frontal 0° luminance may be preferably 400 cd/m² or less, more preferably 300 cd/m² or less, particularly preferably 200 cd/m² or less, and further preferably 150 cd/m² or less. This allows the background visibility to be excellent when the projector is turned off. The details of a method of measuring the luminance in the present specification are as described in the testing example, which will be described later.

Additionally or alternatively, in the projection screen 2 according to the present embodiment, the luminance at diagonal 45° (diagonal 45° luminance) on the hard coat film 1 side as measured using transmitted light from a white light source of 1100 cd/m² may be preferably 10 cd/m² or more, more preferably 20 cd/m² or more, particularly preferably 30 cd/m² or more, and further preferably 50 cd/m² or more. This allows the diagonal visibility to be excellent when the projector is turned on. Additionally or alternatively, the above diagonal 45° luminance may be preferably 400 cd/m² or less, more preferably 300 cd/m² or less, particularly preferably 200 cd/m² or less, and further preferably 150 cd/m² or less. This allows the background visibility to be excellent when the projector is turned off.

### 4. Method of Use

FIG. 3 illustrates an example of use of the projection screen 2 according to the present embodiment. In FIG. 3, the hard coat film 1 is located on the opposite side of a projector P across the optically transparent member 3, but the hard coat film 1 may be located on the same side as the projector P.

When the projection screen 2 is used as a transmissive projection screen (when used as a rear projection screen), as illustrated in FIG. 3, an image is projected from the projector P onto the projection screen 2, and viewers V1 and V2 visually recognize the image projected onto the projection screen 2 from the opposite side of the projection screen 2 to the projector P.

According to the projection screen 2 of the present embodiment, when the projector P is turned on, the image visibility in front of the projection screen 2 (image visibility for the viewer V1) is excellent, and the image visibility in a diagonal direction from the projection screen 2 (e.g., image visibility for the viewer V2) is also excellent. Moreover, when the projector P is turned off, the background on the opposite side of the projection screen 2 can be clearly seen from the viewers V1 and V2, and the background visibility is excellent. Furthermore, there is little change in the luminance depending on the type of display color in the image, and the color tone change is little.

The embodiments heretofore explained are described to facilitate understanding of the present invention and are not described to limit the present invention. It is therefore intended that the elements disclosed in the above embodiments include all design changes and equivalents to fall within the technical scope of the present invention.

### EXAMPLES

Hereinafter, the present invention will be described further specifically with reference to examples, etc., but the scope of the present invention is not limited to these examples, etc.

### Example 1

### 1. Production of Hard Coat Film

The coating liquid of a composition for hard coat layer was obtained through mixing and stirring 50 mass parts (solid content equivalent; here and hereinafter) of dipentaerythritol hexaacrylate (DPHA) and 50 mass parts of polyfunctional urethane acrylate prepolymer (available from TOKUSHIKI Co., Ltd., product name “HCA-150D Clear”) as the active energy ray-curable components, 5 mass parts of 1-hydroxycyclohexyl phenyl ketone as the photopolymerization initiator, 0.3 mass parts of titanium oxide fine particles (P1; available from Sakai Chemical Industry Co., Ltd., product name “R-25,” indefinite shape, average particle diameter: 200 nm, refractive index: 2.7) as the light-diffusing fine particles, and 0.2 mass parts of polydimethylsiloxane (available from Dow Toray Co., Ltd., product name “SH28”) as the silicone-based leveling agent in a mixed solvent in which propylene glycol monomethyl ether and isobutyl alcohol were mixed at a mass ratio of 1:1.

Then, one surface of a polyethylene terephthalate film (available from Toray Industries, Inc., product name “Lumirror #100 U48,” thickness: 100 μm) as the base material film was coated with the above coating liquid of the composition for hard coat layer using a Mayer bar, and the coating liquid was dried by heating at 70° C. for 1 minute to form a layer of the composition for hard coat layer (composition layer).

After that, the above composition layer of the composition for hard coat layer was cured by being irradiated with ultraviolet rays from the composition layer side under the following conditions to form a hard coat layer (thickness: 5 μm), and a hard coat film was thus obtained.

### «Ultraviolet Irradiation Conditions»

Ultraviolet irradiation device: UV irradiation device available from GS Yuasa Corporation
Light source: High-pressure mercury lamp
Lamp power: 1.4 kW
Illuminance: 200 mW/cm²
Light amount: 200 mJ/cm²
Conveyor speed: 1.2 m/min
Ultraviolet irradiation under nitrogen atmosphere (oxygen concentration of 1% or less)
   2. Production of Hard Coat Film with Pressure Sensitive Adhesive Layer

A (meth)acrylic ester polymer was prepared by using a solution polymerization method to copolymerize 70 mass parts of n-butyl acrylate, 20 mass parts of ethyl acrylate, 5 mass parts of methyl methacrylate, 4.5 mass parts of acrylic acid, and 0.5 mass parts of 2-hydroxyethyl acrylate. The molecular weight of the (meth)acrylic ester polymer was measured by the method, which will be described later. The weight-average molecular weight (Mw) was 700,000.

The coating solution of a pressure sensitive adhesive composition was obtained through mixing and sufficiently stirring 100 mass parts (solid content equivalent, here and hereinafter) of the (meth)acrylic ester polymer obtained as above, 0.25 mass parts of an aluminum chelate-based crosslinker (available from Soken Chemical & Engineering Co., Ltd., product name “M-5A”), 0.1 mass parts of an epoxy-based crosslinker (available from Soken Chemical & Engineering Co., Ltd., product name “E-AX”), and 6 mass parts of a triazine-based ultraviolet absorber (available from BASF, product name “Tinuvin 477”) and diluting the mixture with methyl ethyl ketone.

The surface of the hard coat film produced in the above step 1 on the base material film side was coated with the obtained coating solution of the pressure sensitive adhesive composition using a knife coater, and the coating solution was subjected to heating treatment at 90° C. for 1 minute to form a coating layer.

Then, a release sheet was laminated on the above coating layer so that the release-treated surface of the release sheet would be in contact with the coating layer, and they were aged under a condition of 23° C. and 50% RH for 7 days to form a 30 μm thick pressure sensitive adhesive layer having ultraviolet absorbing properties. A hard coat film with the pressure sensitive adhesive layer was thus obtained. The thickness of the pressure sensitive adhesive layer is a value measured using a constant-pressure thickness meter (available from TECLOCK Co., Ltd., product name “PG-02”) in accordance with JIS K7130.

Here, the previously described weight-average molecular weight (Mw) refers to a weight-average molecular weight that is measured as a polystyrene equivalent value under the following conditions using gel permeation chromatography (GPC) (GPC measurement).

### «Measurement Conditions»

GPC measurement device: HLC-8020 available from Tosoh Corporation
GPC columns (passing through in the following order): available from Tosoh Corporation
   TSK guard column HXL-H
   TSK gel GMHXL (×2)
   TSK gel G2000HXL
Solvent for measurement: tetrahydrofuran
Measurement temperature: 40° C.

### Examples 2 to 7 and Comparative Examples 1 and 2

Hard coat films and hard coat films with pressure sensitive adhesive layers were produced in the same manner as in Example 1 except that the types and compounding amounts of the light-diffusing fine particles and the types and compounding amounts of the additives were as listed in Table 1. In Examples 5 and 6, cesium tungsten oxide (available from Sumitomo Metal Mining Co., Ltd., “YMF01,” a composite tungsten oxide containing 33 mol % of cesium relative to tungsten) was added as a near-infrared absorber to the composition for hard coat layer, and in Example 7, a polymethyl methacrylate resin filler (available from Sekisui Kasei Co., Ltd., product name “SSX-103,” true spherical, average particle diameter: 3 μm, refractive index: 1.49) was added as an anti-glare property imparting agent to the composition for hard coat layer.

Here, the details of the simplified names listed in Table 1 are as follows.

### <Light-Diffusing Fine Particles>

P1: Titanium oxide fine particles (available from Sakai Chemical Industry Co., Ltd., product name “R-25,” indefinite shape, average particle diameter: 200 nm, refractive index: 2.7)

P2: Titanium oxide fine particles (available from Sakai Chemical Industry Co., Ltd., product name “R-62N,” indefinite shape, average particle diameter: 260 nm, refractive index: 2.7)

P3: Zinc oxide fine particles (available from Sakai Chemical Industry Co., Ltd., product name “FINEX-50,” indefinite shape, average particle diameter: 20 nm, refractive index: 2.0)

### <Testing Example 1> (Measurement of Refractive Index)

The refractive index of the light-diffusing fine particles used in each of Examples and Comparative Examples was measured by the following method. A sample was prepared through placing fine particles on a slide glass, dropping a refractive index standard solution onto the fine particles, and covering the fine particles with a cover glass. The sample was observed with a microscope, and the refractive index of the refractive index standard solution at which the outline of the fine particles became most difficult to see was determined as the refractive index of the fine particles.

On the other hand, the refractive index of the resin component constituting the hard coat layer in each of Examples and Comparative Examples was measured by the following method.

The coating liquid of a composition for hard coat layer was obtained through mixing and stirring 50 mass parts of dipentaerythritol hexaacrylate and 50 mass parts of polyfunctional urethane acrylate prepolymer (available from TOKUSHIKI Co., Ltd., product name “HCA-150D Clear”) as the active energy ray-curable components and 5 mass parts of 1-hydroxycyclohexyl phenyl ketone as the photopolymerization initiator in a mixed solvent in which methyl isobutyl ketone and cyclohexanone were mixed at a mass ratio of 1:1.

Using the coating liquid of the above composition for hard coat layer, a hard coat layer having a thickness of 5 μm was formed in the same manner as in each of Examples and Comparative Examples on the untreated surface of a polyethylene terephthalate film (available from TOYOBO CO., LTD., product name “COSMOSHINE A4100,” thickness: 50 μm), one surface of which was treated for easy adhesion. Then, the polyethylene terephthalate film's surface treated for easy adhesion was rubbed with sandpaper and painted black with an oil-based pen (available from ZEBRA CO., LTD., product name “Mckee Black”).

After that, the refractive index of the above hard coat layer was measured using a spectroscopic ellipsometer (available from J.A. WOOLLAM, product name “M-2000”) under conditions of a measurement wavelength of 589 nm and a measurement temperature of 25° C. in accordance with JIS K7142 (2008). The results are listed in Table 1.

The refractive index of the hard coat layer (resin component constituting the hard coat layer) was subtracted from the refractive index of the light-diffusing fine particles measured above to calculate the refractive index difference. The results are listed in Table 1.

### <Testing Example 2> (Measurement of Haze Value)

For the hard coat film produced in each of Examples and Comparative Examples, the total luminous haze value (%) was measured using a haze meter (available from NIPPON DENSHOKU INDUSTRIES CO., LTD., product name “NDH-5000”) in accordance with JIS K7136: 2000.

In addition, for the hard coat film produced in each of Examples and Comparative Examples, the haze values (%) in a wavelength region of 380 nm to 780 nm were measured at a pitch of 5 nm using a spectroscopic haze meter (available from NIPPON DENSHOKU INDUSTRIES CO., LTD., product name “SH-7000”). Then, the minimum haze value and maximum haze value in a wavelength region of 400 nm to 700 nm (visible light region) were extracted, and the haze value ratio of the maximum haze value to the minimum haze value (maximum haze value/minimum haze value) was calculated. In addition, the average value of haze values in the wavelength region of 400 nm to 700 nm (visible light range) was calculated. The results are listed in Table 2.

### Testing Example 3(Measurement of Luminous Transmittance)

For the hard coat film produced in each of Examples and Comparative Examples, the total luminous transmittance (%) was measured using a haze meter (available from NIPPON DENSHOKU INDUSTRIES CO., LTD., product name “NDH-5000”) in accordance with JIS K7361-1: 1997.

In addition, for the hard coat film produced in each of Examples and Comparative Examples, the luminous transmittances (%) in a wavelength region of 380 nm to 780 nm were measured at a pitch of 5 nm using a spectroscopic haze meter (available from NIPPON DENSHOKU INDUSTRIES CO., LTD., product name “SH-7000”). Then, the average value of luminous transmittances in a wavelength region of 400 nm to 700 nm (visible light range) was calculated. In addition, the luminous transmittance (%) at 1100 nm was extracted. The results are listed in Table 2.

### Testing Example 4(Measurement/Evaluation of Luminance)

The release sheet was removed from the hard coat film with the pressure sensitive adhesive layer produced in each of Examples and Comparative Examples, then the hard coat film with the pressure sensitive adhesive layer was attached to a soda lime glass of 300 mm width×400 mm length×1.1 mm height via the exposed pressure sensitive adhesive layer, and a projection screen was thus obtained.

A short focus projector (available from RICOH COMPANY, LTD., product name “PJ WX4152N”) was installed at a position of 15 cm from the projection screen and on the opposite side to the hard coat film side of the projection screen. Then, in a dark room environment, a white image (white light) was projected onto the projection screen so that the luminance of the projection screen would be 1100 cd/m².

The luminance of the white light projected onto the projection screen was measured using a luminance meter (available from KONICA MINOLTA, INC., product name “LS-110”) from angles of frontal 0° (directly in front of the projector) and diagonal 45° on the hard coat film side of the projection screen. The results are listed in Table 2.

In addition, in the same darkroom environment as above, short wavelength (400 nm to 500 nm) light (blue light), medium wavelength (500 nm to 600 nm) light (green light), and long wavelength (600 nm to 700 nm) light (red light) were projected onto the projection screen.

The luminance of each color of light projected onto the projection screen was visually confirmed at a position of frontal 0° (directly in front of the projector) on the hard coat film side of the projection screen. The luminance evaluation was performed at a position of 100 cm from the projection screen. Then, the luminance of each color of light was evaluated based on the following criteria. The results are listed in Table 2.
5 . . . Very high luminance
4 . . . High luminance
3 . . . Moderate luminance
2 . . . Low luminance
1 . . . Very low luminance

### <Testing Example 5> (Evaluation of Frontal Visibility/Diagonal Visibility)

The projection screen was produced in the same manner as in Testing Example 4. Then, a short focus projector (available from RICOH COMPANY, LTD., product name “PJ WX4152N”) was installed at a position of 100 cm from the projection screen and on the opposite side to the hard coat film side of the projection screen. Then, the TV's inactive image (in which rectangular figures were arranged with various colors) was projected from the projector onto the projection screen.

The image projected onto the projection screen was visually confirmed from angles of frontal 0° (directly in front of the projector) and diagonal 45° on the hard coat film side of the projection screen (see FIG. 3). The viewer confirmed the projected image at a position 100 cm away from the projection screen. Then, the frontal visibility and the diagonal visibility were evaluated based on the following criteria. The results are listed in Table 2.
⊚: Boundaries of the image were clearly visible.
O: Boundaries of the image were recognizable.
X: The image was not recognizable.

### <Testing Example 6> (Evaluation of Background Visibility)

The projection screen was produced in the same manner as in Testing Example 4. Then, an A4 sheet of paper on which characters (A, B, and C) and figures (o, Δ, and x) were displayed was placed at a position 100 cm away from the projection screen and on the opposite side to the hard coat film of the projection screen. The font size of these characters and figures was 144 points.

Then, in a state in which no image was projected from the projector, the characters/figures as a background were visually confirmed through the projection screen. The viewer confirmed the characters/figures at a position 100 cm away from the projection screen. Then, the background visibility was evaluated based on the following criteria. The results are listed in Table 2.
⊚: Characters/figures were clearly confirmed.
O: Characters/figures were recognizable.
X: Characters/figures were not recognizable.

### <Testing Example 7> (Evaluation of Anti-Glare Properties)

The hard coat film with the pressure sensitive adhesive layer produced in each of Examples and Comparative Examples was attached to one surface of a black plate (available from Yukou Trading Co., Ltd., product name “Acrylite”) via the pressure sensitive adhesive layer. For the obtained laminate of the hard coat film with the pressure sensitive adhesive layer and the black plate, a three-wavelength fluorescent lamp was turned on above the laminate, and the light was reflected by the hard coat film. The reflected light was visually observed, and the anti-glare properties were evaluated based on the following criteria. The results are listed in Table 2.

O: The visually recognized contour of the fluorescent lamp due to reflection on the hard coat film was blurred.

Δ: The visually recognized contour of the fluorescent lamp due to reflection on the hard coat film was slightly blurred.

X: The visually recognized contour of the fluorescent lamp due to reflection on the hard coat film was not blurred.

TABLE 1

| | Composition formula | | | | Refractive index | | |
|---|---|---|---|---|---|---|---|
| | Light-diffusing | | | | | | Refractive |
| | fine particles | | Additive | | Light-diffusing | Resin | index |
| | Type | mass parts | Type | mass parts | fine particles | component | difference |
| Example 1 | P1 | 0.3 | — | — | 2.7 | 1.5 | 1.2 |
| Example 2 | P2 | 0.3 | | | | | |
| Example 3 | | 0.5 | | | | | |
| Example 4 | | 1.0 | | | | | |
| Example 5 | | 0.4 | Near-infrared | 10 | | | |
| Example 6 | | 0.5 | absorber | 20 | | | |
| Example 7 | | 0.5 | Anti-glare property | 3 | | | |
| | | | imparting agent | | | | |
| Comparative | P3 | 2.5 | — | — | 2.0 | | 0.5 |
| Example 1 | | | | | | | |
| Comparative | — | — | | | — | | 0.0 |
| Example 2 | | | | | | | |

TABLE 2

| | Optical properties | | | | | | | | |
|---|---|---|---|---|---|---|---|---|---|
| | Haze value | | | | | Luminous transmittance | | | Projection screen |
| | | Average | | | | | Average | | performance |
| | Total | value in | | | | Total | value in | | Luminance |
| | luminous | visible | Maximum | Minimum | | luminous | visible | Transmittance | (cd/m²) |
| | haze value | light region | haze value | haze value | Haze value | transmittance | light region | at 1.100 nm | Frontal 0° |
| | (%) | (%) | (%) | (%) | ratio | (%) | (%) | (%) | luminance |
| Example 1 | 4.5 | 5.0 | 5.5 | 3.3 | 1.67 | 89.7 | 89.8 | 87.2 | 32 |
| Example 2 | 4.3 | 4.7 | 5.2 | 3.2 | 1.65 | 89.6 | 89.8 | 87.1 | 30 |
| Example 3 | 8.4 | 8.6 | 9.0 | 6.0 | 1.51 | 88.8 | 88.9 | 86.8 | 76 |
| Example 4 | 18.2 | 18.3 | 18.7 | 11.7 | 1.59 | 86.7 | 86.8 | 86.6 | 120 |
| Example 5 | 5.4 | 5.6 | 6.4 | [symbol] .5 | 1.81 | 82.7 | 83.5 | 44.3 | 35 |
| Example 6 | 6.8 | 7.6 | 7.8 | 4.5 | 1.74 | 77.7 | 78.4 | 23.9 | 38 |
| Example 7 | 13.0 | 13.2 | 14.9 | 11.1 | 1.34 | 89.0 | 89.1 | 87.0 | 97 |
| Comparative | 4.4 | 4.7 | 13.5 | 1.9 | 7.11 | 89.5 | 89.7 | 85.8 | 3 [symbol] |
| Example 1 | | | | | | | | | |
| Comparative | 0.5 | 0.5 | 0.5 | 0.5 | 1 | 90.1 | 90.1 | 89.8 | 4 |
| Example 2 | | | | | | | | | |

| | Projection screen performance | | | | | | | |
|---|---|---|---|---|---|---|---|---|
| | Luminance | | | | | | | |
| | (cd/m²) | Luminance evaluation | | | | | | Evaluation |
| | Diagonal | Short | Medium | Long | | | | of |
| | 45° | wavelengths | wavelengths | wavelengths | Frontal | Diagonal | Background | anti-glare |
| | luminance | (blue) | (green) | (red) | visibility | visibility | visibility | properties |
| Example 1 | 30 | 3 | 4 | 4 | ○ | ○ | ⊚ | Δ |
| Example 2 | 28 | 3 | 4 | 4 | ○ | ○ | ⊚ | Δ |
| Example 3 | 75 | 3 | 5 | 4 | ⊚ | ⊚ | ⊚ | Δ |
| Example 4 | 119 | 4 | 5 | 5 | ⊚ | ⊚ | ○ | Δ |
| Example 5 | 34 | 4 | 5 | 4 | ⊚ | ⊚ | ⊚ | Δ |
| Example 6 | 37 | 5 | 5 | 4 | ⊚ | ⊚ | ⊚ | Δ |
| Example 7 | 95 | 4 | 4 | 4 | ⊚ | ⊚ | ○ | ○ |
| Comparative | 30 | 4 | 3 | 2 | ○ | ○ | ○ | Δ |
| Example 1 | | | | | | | | |
| Comparative | 2 | 1 | 1 | 1 | x | x | ⊚ | x |
| Example 2 | | | | | | | | |

[symbol]

indicates data missing or illegible when filed

As found from Table 2, the hard coat films and projection screens produced in Examples were excellent in the frontal visibility and diagonal visibility when the projector was turned on, and were also excellent in the background visibility when the projector was turned off. Moreover, there was little change in the luminance depending on the type of display color.

### INDUSTRIAL APPLICABILITY

The hard coat film and projection screen of the present invention are suitably used for a transmissive projection screen using a show window, window glass, etc.

### DESCRIPTION OF REFERENCE NUMERALS

1 . . . Hard coat film
   11 . . . Base material film
   12 . . . Hard coat layer
2 . . . Projection screen
   21 . . . Pressure sensitive adhesive layer
   3 . . . Optically transparent member
P . . . Projector
V1, V2 . . . Viewer

1. A hard coat film for a projection screen, comprising:
a base material film; and
a hard coat layer formed on one surface side of the base material film, wherein
a total luminous haze value is 1% or more and 60% or less, and
a ratio of a maximum haze value to a minimum haze value in a wavelength region of 400 nm to 700 nm is less than 7.

2. The hard coat film for a projection screen according to claim 1, wherein an average value of haze values in the wavelength region of 400 nm to 700 nm is 2.0% or more and 60% or less.

3. The hard coat film for a projection screen according to claim 1, wherein an average value of luminous transmittances in the wavelength region of 400 nm to 700 nm is 60% or more and 98% or less.

4. The hard coat film for a projection screen according to claim 1, wherein a total luminous transmittance is 60% or more.

5. The hard coat film for a projection screen according to claim 1, wherein the hard coat layer contains light-diffusing fine particles.

6. The hard coat film for a projection screen according to claim 5, wherein the light-diffusing fine particles have a refractive index of 1.8 or more.

7. The hard coat film for a projection screen according to claim 5, wherein a difference between a refractive index of a resin component constituting the hard coat layer and the refractive index of the light-diffusing fine particles is 0.5 or more in absolute value.

8. The hard coat film for a projection screen according to claim 5, wherein a content of the light-diffusing fine particles in the hard coat layer is 0.01 mass parts or more and 10 mass parts or less with respect to 100 mass parts of a resin main component constituting the hard coat layer.

9. A projection screen comprising:
the hard coat film for a projection screen according to claim 1;
a pressure sensitive adhesive layer laminated on a surface side of the hard coat film for a projection screen opposite to the hard coat layer; and
an optically transparent member laminated on a surface side of the pressure sensitive adhesive layer opposite to the hard coat film for a projection screen.
